(19) United States
(12) Patent Application Publication
(10) Pub. No.: US 2018/0090841 A1
(43) Pub. Date: Mar. 29, 2018

(54) LOW PROFILE ANTENNA WITH GOOD GAIN IN ALL DIRECTIONS ALONG HORIZON

(71) Applicant: Micro-Ant, LLC, Jacksonville, FL (US)

(72) Inventors: Charles McCarrick, JACKSONVILLE, FL (US); Philip J. Koh, Jacksonville, FL (US); James Messink, Jacksonville, FL (US)

(73) Assignee: MICRO-ANT, LLC, Jacksonville, FL (US)

(21) Appl. No.: 15/444,371

(22) Filed: Feb. 28, 2017

Related U.S. Application Data
(60) Provisional application No. 62/398,997, filed on Sep. 23, 2016.

(51) Int. Cl. H01Q 9/04; H01Q 1/38; H01Q 1/48; H01Q 1/32; H01Q 5/335

(52) U.S. Cl. CPC H01Q 9/0407; H01Q 1/38; H01Q 5/335; H01Q 1/32; H01Q 1/48

(57) ABSTRACT

A low profile patch antenna surface mounted to a metal base produces superior gain in horizontal directions. A dielectric spacer and matching circuit are sandwiched between a thin circular patch radiator and an opposite ground plate, with the matching circuit between the spacer and ground plate and electrically coupled to the ground plate and radiator. The matching circuit increases antenna efficiency and bandwidth by attaining the best possible energy transfer between a transceiver and the antenna, taking into account impedance mismatch, component losses, and losses in the antenna structure.

### FIELD OF THE INVENTION

The present invention generally relates to a low profile antenna that can be surface mounted to a base and produces superior gain in horizontal directions.

### BACKGROUND

Often an antenna must be mounted to a base. As one example, antennas that communicate utility usage data are often mounted to a metal lid of a container that houses a meter. One such example is a water meter. Other examples include electric, gas and sewage meters.

To meet legal requirements, when surface mounted in a place with pedestrian access, such antennas must have a low profile (e.g., no more than 13 mm in height), including any radome.

By way of example and not limitation, many water meters are contained in a pit that extends below ground level. The pit has an open top. A removable pit lid covers the top of the pit. The pit lid may be comprised of various materials, including cement, plastic or metal.

To economically read water meters, manual meter reading has been replaced with remote meter reading units. Modern meters include components to determine the volume of water that has flowed through the meter. As one example, a meter may include a register comprising a sensor to detect the rotation of the components within the meter and generate an electrical count of the volume of water that flows through the meter. The recorded data from the meter is broadcast as an RF signal by a transmitter or transceiver coupled to an antenna. The antenna may extend slightly above the pit lid to facilitate transmission of the RF signal away from the meter pit. The RF signal can be read from a remote location.

Material close to the antenna may affect the efficiency of the antenna in radiating the desired RF signals. In some cases, the pit lid is formed from a metallic material, such as iron, that significantly inhibits the transmission of RF signals using conventional prior art antennas.

Regardless of the lid material, the range of conventional water meter antennas is quite limited, perhaps about ¼ mile depending upon various factors and conditions. Consequently, a remote reading system is required within ¼ mile of each meter. Increasing the range of an antenna from ¼ mile to about 1 mile would decrease the required number of remote meter reading systems to 1/16th.

An antenna must not only provide adequate RF performance, but withstand physical conditions. Currently, such antennas are being used on sidewalks where pedestrian traffic may interact with the antenna assembly and in areas of heavy vehicular traffic. Thus, an antenna must feature a low profile and a small width or diameter that does not extend to the edge of the pit lid. The antenna must also exhibit sufficient structural integrity to withstand forces of pedestrian and vehicle traffic.

The invention is directed to overcoming one or more of the problems and solving one or more of the needs as set forth above.

### SUMMARY OF THE INVENTION

To solve one or more of the problems set forth above, in an exemplary implementation of the invention, an antenna for mounting to a surface (e.g., an underground utility meter with a pit lid) is provided. The antenna is a low profile patch antenna that can be surface mounted to a base and produces superior gain in horizontal directions. The antenna may be mounted to a metallic or non-metallic surface, on a pit lid, a vehicel, equipment or other object.

The antenna comprises a thin circular (disc shaped) patch radiator and an opposite aligned ground plate. A narrow uniform space (less than 13 mm) is maintained between the radiator and ground plate. An optional dielectric spacer occupies the space between the radiator and ground plate. An impedance matching circuit is mounted between the dielectric and ground plate and electrically coupled to both the ground plate and radiator, as well as to an input channel (e.g., coaxial coupling to a meter assembly).

An exemplary matching circuit improves impedance matching between the input channel and the radiator. The impedance matching circuit may include a passive element from the group consisting of a series inductor, a series capacitor, a shunt inductor and a shunt capacitor, etched on the printed circuit board.

An input channel supplies radio frequency signals. The impedance matching circuit includes an input coupled to the input channel and an output coupled to the radiator.

An embodiment for a pit lid may include a ground plate with a cylindrical hub protruding away from the radiator. The pit lid (i.e., the cover) may include a bore (opening) sized (i.e., shaped and sized) to receive the cylindrical hub. Thus, the cylindrical hub extends into the bore.

### BRIEF DESCRIPTION OF THE DRAWINGS

The foregoing and other aspects, objects, features and advantages of the invention will become better understood with reference to the following description, appended claims, and accompanying drawings, where:

FIG. 1 is a schematic view of a water meter in a pit with a metal cover having mounted thereon an exemplary antenna assembly according to principles of the invention; and

FIG. 2 is a top perspective view of an exemplary antenna assembly according to principles of the invention; and

FIG. 3 is a bottom perspective view of an exemplary antenna assembly according to principles of the invention; and

FIG. 4 is a top exploded view of an exemplary antenna assembly according to principles of the invention; and

FIG. 5 is a top perspective view of an exemplary radiator for an antenna according to principles of the invention; and

FIG. 6 is a profile view of an exemplary radiator for an antenna according to principles of the invention; and

FIG. 7 is a bottom perspective view of an exemplary radiator for an antenna according to principles of the invention; and

FIG. 8 is a top perspective view of an exemplary dielectric spacer for an antenna according to principles of the invention; and

FIG. 9 is a bottom perspective view of an exemplary dielectric spacer for an antenna according to principles of the invention; and

FIG. 10 is a top perspective view of an exemplary ground plate for an antenna according to principles of the invention; and

FIG. 11 is a bottom perspective view of an exemplary ground plate for an antenna according to principles of the invention; and

Those skilled in the art will appreciate that the figures are not intended to be drawn to any particular scale; nor are the figures intended to illustrate every embodiment of the invention. The invention is not limited to the exemplary embodiments depicted in the figures or the specific components, configurations, shapes, relative sizes, ornamental aspects or proportions as shown in the figures.

### DETAILED DESCRIPTION

An exemplary implementation of the invention is as a low profile antenna mounted to a pit lid for a water meter. However, the principles of the invention may be applied to other systems that include a metal or non-metallic mounting surface. The invention is not limited to use with water meter housings or metal pit lids. Such other systems may include vehicles (e.g., planes trains, and automobiles), buildings and equipment. An antenna according to principles of the invention may be particularly useful for wireless communication of data to and from connected smart devices for the Internet of Things.

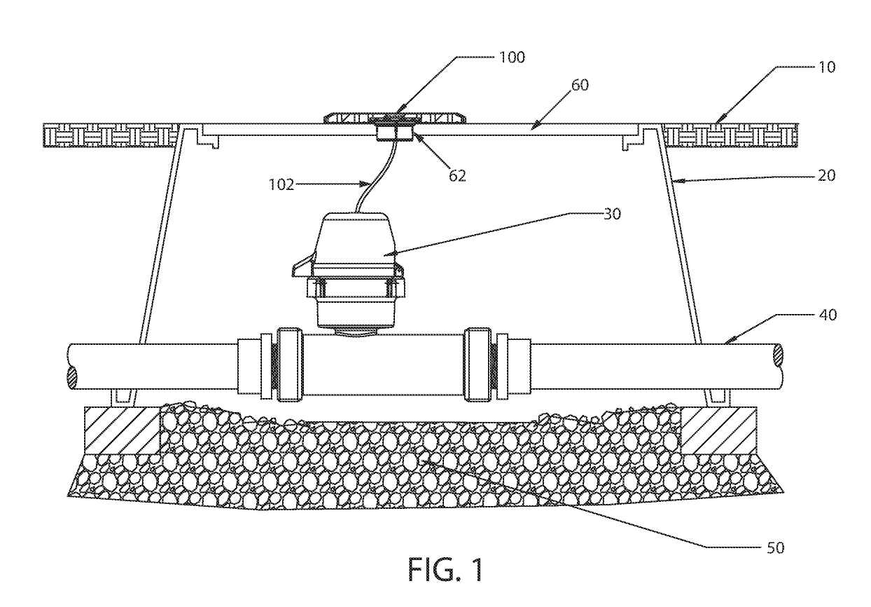

With reference to FIG. 1, a water meter 30 is shown, in a pit 20, with a gravel base 50, below grade 10. In the exemplary embodiment, an antenna assembly 100 according to principles of the invention is mounted on a lid (aka “pit lid), which may be a metal lid 60. The meter 30 determines the volume of water flowing through the pipe 40. The antenna assembly 100, which is operably coupled to the meter 30, via a cable (e.g., coaxial cable) 102, receives and/or transmits RF signals. The exemplary antenna assembly 100 operates at a determined frequency, for example, at 460 MHz. It features a low profile, laying nearly flat to the surface of the metal lid 60. By way of example, the antenna assembly, including any radome, should not protrude above the lid by more than 13 mm. Otherwise it would constitute a trip hazard and impediment to mobility.

The antenna assembly 100 launches a vertically polarized wave with good gain at low elevations in all directions along the horizon. Good gain in the zenith direction is not required.

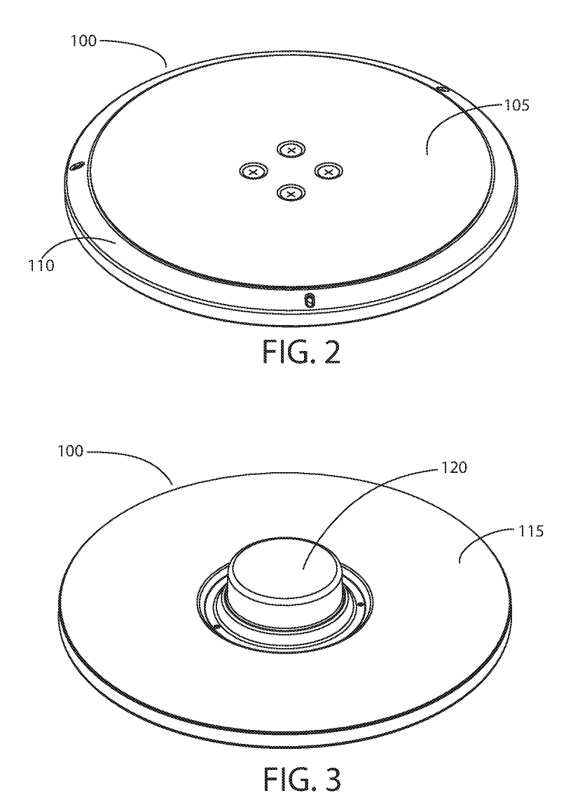

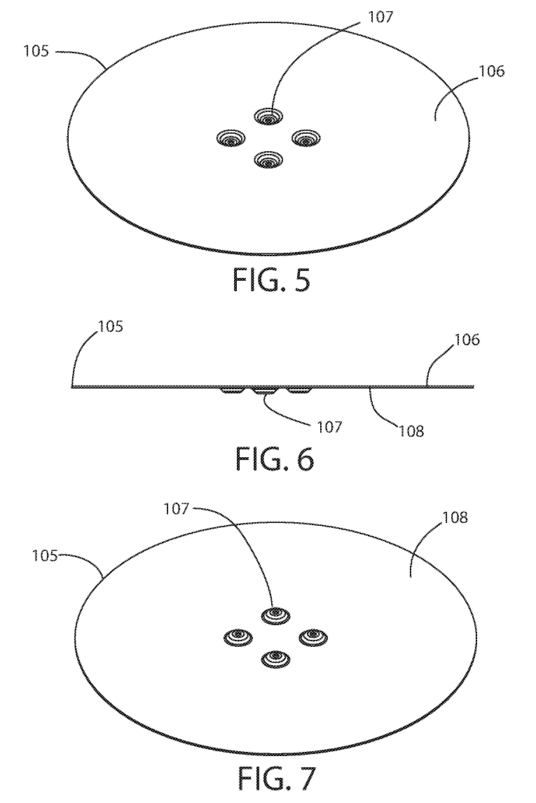

With reference to FIGS. 2, 5-7, the antenna assembly 100 includes a top radiator 105 (i.e., a patch), which is a flat metal plate. In the exemplary embodiment, the radiator 105 is a thin circular (disk-shaped) patch. The exemplary radiator has a top surface 106, a bottom surface 108, and a plurality of mounting holes 107. In the exemplary embodiment, the mounting holes 107 are recessed.

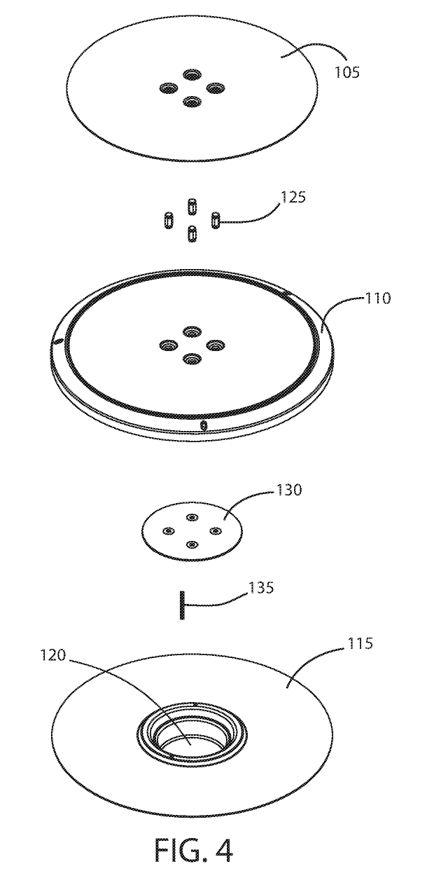

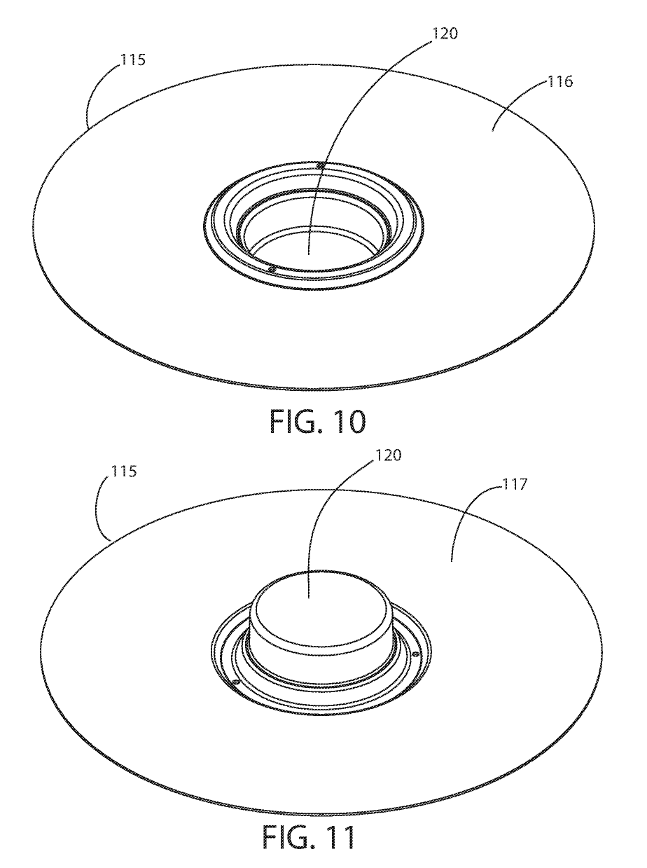

The antenna assembly 100 also includes a ground plate 115, as shown in FIGS. 3, 4, 10 and 11. The exemplary ground plate 115 is a stamped steel disk with an integral deep drawn generally cylindrical hub 120. The disk has a top surface 116 that faces the radiator 105 and a bottom surface 117 that lays against the metal lid 60. The hub 120 extends through a bore 62 in the lid 60, as shown in FIG. 1. The hub 120 also defines a compartment 122 that provides volume for containing antenna components. The hub 120 and bore 62 are shaped and sized to allow the hub 120 to contact the sides of the bore 62 of the metal lid 60. Thus, the ground plate 115 couples strongly to the metal lid 60 on which the antenna 100 is mounted. Electrically, the ground plate 115 and the metal lid 60 may be one piece, or they may be two pieces in electrical contact, or they may be two metal parts separated by dielectric such as plastic for sealing and water-tightness. Together, the ground plate 115 and metal lid 60 provide an electrical ground for the antenna. Mechanical couplings 125 join components together into an assembly.

The integral deep drawn generally cylindrical hub 120 is convenient for mounting to a pit lid with a corresponding bore, but may not be required in other applications. If an antenna according to principles of the invention is mounted to a planar surface, the hub 120 may be omitted. If an antenna according to principles of the invention is mounted to a planar surface without a corresponding bore, the hub 120 would interfere with surface mounting and should, therefore, be omitted.

Space between the radiator 105 and ground plate 115 should be substantially uniform and relatively small (e.g., less than 1-inch, preferably less than ½-inch, and more preferably less than 13 mm) to provide a low profile. The space between the radiator 105 and ground plate 115 is evacuated or substantially filled with air, solid dielectric, or a composite dielectric. In one embodiment, a spacer 110 comprised of a material with a low dielectric constant maintains the space between the radiator 105 and ground plate 115. The spacer 110 may be structurally reinforced to withstand loads and impacts without compromising antenna performance.

A parasitic capacitor is formed between the radiator 105 and closely spaced ground plate 110. It is desirable to reduce the capacitance of the parasitic capacitor in order to improve gain and bandwidth. As the capacitance is proportional to the dielectric constant of the substance between the plates, minimizing the dielectric constant in the space between the radiator 105 and ground plate 115 substantially reduces the capacitance of the parasitic capacitor.

The radiator 105 may be mounted to a spacer 110 via a plurality of mounting holes 113 in alignment with the mounting holes 107 of the radiator 105. The mounting holes 113 in the spacer 110 may be threaded.

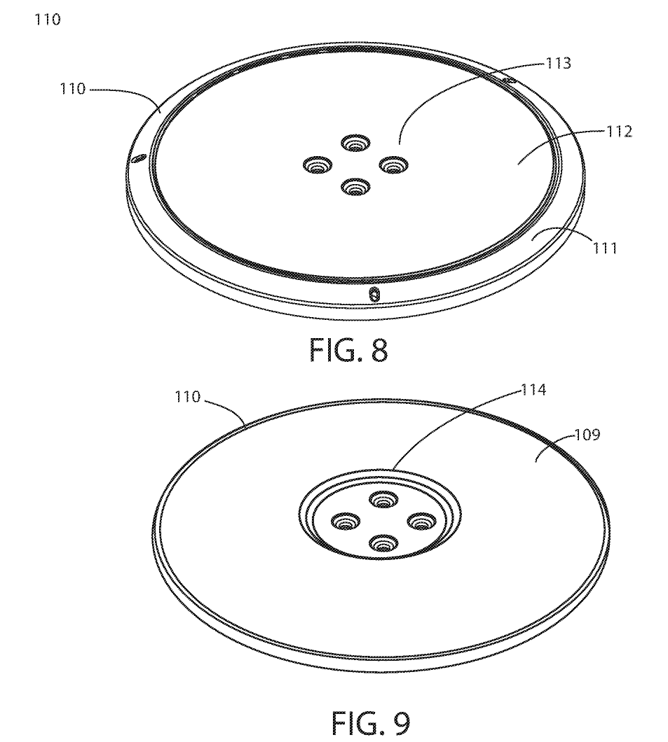

With reference to FIGS. 8 and 9, an impedance matching circuit 130 is provided to ensure most of the power from the RF source is delivered to the load. The impedance matching circuit is thin enough to fit between the radiator 105 and ground plate 115, without compromising performance. An exemplary impedance matching circuit may comprise one or more passive devices, such as a series inductor, series capacitor, shunt inductor and shunt capacitor. While resistors may be used to achieve matching, the consequent power loss is undesirable. By adding series and shunt elements, a desired impedance may be achieved, matching a load impedance to a source or to a complex conjugate of the source.

Each element of the impedance matching circuit may comprise a discrete element or printed circuit board (PCB) printed (e.g., etched) components. A PCB printed impedance matching circuit is thin enough to fit within the narrow space between the radiator 105 and ground plate 115. In an embodiment with a spacer 110 between the radiator 105 and ground plate 115, the spacer 110 may include a compartment or recess for receiving the impedance matching circuit 130. Alternatively, the spacer 110 may be divided into separate portions (e.g., halves) and the impedance matching circuit may be disposed (e.g., sandwiched) between the spacer portions, between the radiator 105 and ground plate 115.

While the invention is not limited to a specific matching circuit, an exemplary matching circuit increases antenna efficiency and bandwidth, not necessarily by precisely matching impedance (which can be achieved by simply adding enough loss), but by attaining the best possible energy transfer between the transceiver and the antenna, taking into account impedance mismatch, component losses, and losses in the antenna structure. In one embodiment, capacitors may be symmetrically arranged. In this embodiment, capacitors may be mirrored around the center point of the antenna, and an inductor may be placed exactly between them on the center line of the antenna.

While the invention has been described in connection with a pit lid for a water meter as a non-limiting example, the principles of the invention may be applied to other systems that include a metal mounting surface. The invention is not limited to use with water meter housings or metal pit lids.

While an exemplary embodiment of the invention has been described, it should be apparent that modifications and variations thereto are possible, all of which fall within the true spirit and scope of the invention. With respect to the above description then, it is to be realized that the optimum relationships for the components and steps of the invention, including variations in order, form, content, function and manner of operation, are deemed readily apparent and obvious to one skilled in the art, and all equivalent relationships to those illustrated in the drawings and described in the specification are intended to be encompassed by the present invention. The above description and drawings are illustrative of modifications that can be made without departing from the present invention, the scope of which is to be limited only by the following claims. Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents are intended to fall within the scope of the invention as claimed.

What is claimed is:

1. A low profile patch antenna comprising:
a radiator comprising a first metal plate that is generally planar;
a ground plate comprising a second metal plate, the ground plate being spaced apart from and aligned with the radiator, the radiator being separated from the ground plate by a substantially uniform distance less than 1 inch;
an input channel, said input channel supplying radio frequency signals;
an impedance matching circuit between the ground plate and the radiator, the impedance matching circuit including an input coupled to said input channel and an output coupled to said radiator, the impedance matching circuit improving impedance matching between the input channel and the radiator.

2. The low profile patch antenna of claim 1, further comprising a dielectric spacer occupying the substantially uniform distance between the radiator and ground plate.

3. The low profile patch antenna of claim 2, the dielectric spacer comprising a solid material.

4. The low profile patch antenna of claim 1, the substantially uniform distance being less than 13 mm.

5. The low profile patch antenna of claim 1, the impedance matching circuit comprising a passive element from the group consisting of a series inductor, a series capacitor, a shunt inductor and a shunt capacitor.

6. The low profile patch antenna of claim 5, the impedance matching circuit comprising a printed circuit board.

7. The low profile patch antenna of claim 6, the passive element being etched on the printed circuit board.

8. The low profile patch antenna of claim 1, further comprising a metal mounting surface and the ground plate being mounted to the metal mounting surface.

9. The low profile patch antenna of claim 8, the metal mounting surface comprising a metal pit lid.

10. The low profile patch antenna of claim 8, the metal mounting surface comprising a vehicle surface.

11. The low profile patch antenna of claim 8, the metal mounting surface comprising an equipment surface.

12. The low profile patch antenna of claim 1, further comprising a non-metallic mounting surface and the ground plate being mounted to the non-metallic mounting surface.

13. The low profile patch antenna of claim 12, the non-metallic mounting surface comprising a non-metallic pit lid.

14. The low profile patch antenna of claim 12, the non-metallic mounting surface comprising a vehicle surface.

15. The low profile patch antenna of claim 12, the non-metallic mounting surface comprising an equipment surface.

16. A pit lid comprising:
a cover disposed over a meter;
a radiator comprising a first metal plate that is generally planar;
a ground plate comprising a second metal plate, the ground plate being spaced apart from and aligned with the radiator, the radiator being separated from the ground plate by a substantially uniform distance less than 13 mm, and the ground plate being mounted on the cover;
an input channel, said input channel supplying radio frequency signals;
an impedance matching circuit between the ground plate and the radiator, the impedance matching circuit including an input coupled to said input channel and an output coupled to said radiator, the impedance matching circuit improving impedance matching between the input channel and the radiator.

17. The pit lid of claim 16, the ground plate including a cylindrical hub, the cylindrical hub protruding away from the radiator.

18. The pit lid of claim 17, the cover including a bore sized to receive the cylindrical hub, the cylindrical hub extending into the bore.

19. The pit lid of claim 16, further comprising a dielectric spacer occupying the substantially uniform distance between the radiator and ground plate.

20. The pit lid of claim 16, the impedance matching circuit comprising a printed circuit board with a passive element from the group consisting of a series inductor, a series capacitor, a shunt inductor and a shunt capacitor, the passive element being etched on the printed circuit board.
